(19) United States
(12) Patent Application Publication
(10) Pub. No.: US 2016/0356192 A1
(43) Pub. Date: Dec. 8, 2016

(54) LOCATING PIN

(71) Applicant: INTERNATIONAL ENGINE INTELLECTUAL PROPERTY COMPANY, LLC, Lisle, IL (US)

(72) Inventors: Jeffrey R Kelso, Ft, .Wayne, IN (US); Gregory G. Hafner, Columbia, SC (US)

(73) Assignee: International Engine Intellectual Property Company LLC, Lisle, IL (US)

(21) Appl. No.: 14/786,421

(22) PCT Filed: Apr. 22, 2013
(86) PCT No.: PCT/US13/37549

§ 371 Date: Oct. 22, 2015

(51) Int. Cl. F01N 3/20; G06K 19/07; G06K 7/10; B01D 53/92; F01N 3/28

(52) U.S. Cl. CPC F01N 3/206; B01D 53/92; F01N 3/2896; G06K 7/10366; G06K 19/0723; B01D 2251/2062; B01D 2258/012; F01N 2900/1814

(57) ABSTRACT

Systems and methods for tracking and indicating a status for the deliverable reductant, such as ammonia, in a canister used in an exhaust gas after-treatment system are disclosed. An on-board system provides a visual display to indicate either generally or specifically the fill-status of each of a plurality of loaded ammonia canisters, while a separate canister system is able to be periodically updated while on-line and, using a memory device such as a RFID tag, carry the updated fill-status even when it is removed from the vehicle system. The residing memory device can be read off-line to determine the ammonia fill-status. Metering of the ammonia flow allows real-time monitoring and updating of the canister status.

### TECHNICAL FIELD

The present device and methods relate to status indicators for containers. More specifically, the device and methods relate to content status indicators, such as “full” or “empty,” for canisters (or cartridges) containing a reductant used on internal combustion engines for exhaust gas after-treatment systems.

### BACKGROUND

Compression ignition engines provide advantages in fuel economy, but produce both NOₓ and particulates during normal operation. New and existing regulations continually challenge manufacturers to achieve good fuel economy and reduce the particulates and NO emissions. Lean-burn engines achieve the fuel economy objective, but the high concentrations of oxygen in the exhaust of these engines yields significantly high concentrations of NOₓ as well. Accordingly, the use of NOₓ reducing exhaust treatment schemes is being employed in a growing number of systems.

One such system is the direct addition of a reductant, such as ammonia gas to the exhaust stream. It is an advantage to deliver ammonia directly in the form of a gas, both for simplicity of the flow control system and for efficient mixing of the reducing agent, ammonia, with the exhaust gas. The direct use of ammonia also eliminates potential difficulties related to blocking of the dosing system, which difficulties are typically caused by, e.g., precipitation or impurities in a liquid-based urea solution. In addition, an aqueous urea solution cannot be dosed at a low engine load since the temperature of the exhaust line would be too low for complete conversion of urea to ammonia (and CO₂).

Due to its caustic nature, transporting ammonia as a pressurized liquid can be hazardous if the container bursts as the result of an accident or if a valve or tube breaks. In the case of using a storage medium, the safety issues are much less critical since a small amount of heat is required to release the ammonia and the equilibrium pressure at room temperature can be—if a proper solid material is chosen—well below 1 bar. Solid ammonia adsorbing/desorbing material in a granular or powder form can be provided as disks or balls loaded into a cartridge or canister. The canisters are then loaded into a mantle or other storage device and secured to the vehicle for use. Appropriate heat is applied to the canisters, which then causes the ammonia-containing storage material to release ammonia gas from the canister into a feed line where it is metered into the exhaust system of a vehicle, for example.

However, as the ammonia leaves the canister, it is in gas form and presents a potential hazard if released through an improper canister connection or through a broken feed line. Even a small leak could be problematic if only for the loss of ammonia, which may deplete the source earlier than scheduled replacement.

Further, as alluded to above, eventually the ammonia in a canister is depleted and must be recharged or replaced. Unfortunately, there are no systems in place which are capable of indicating the fill-status of a canister. This shortcoming requires a plurality of canisters to be used in a vehicle system in order to provide a level of redundancy. Further, the canisters are typically changed on a regular basis, regardless of the fill-level, to avoid the possibility of ammonia depletion during engine operation. The result is sometimes the carrying of too much ammonia to provide the desired redundancy, and sometimes the removal and replacement of partially-filled ammonia canisters with full canisters to avoid depletion. Such conditions and procedures may increase the possibility of an accidental ammonia release.

Thus, the present system and methods provide an on-board indication of a proper connection between the ammonia canister and the ammonia feed line. The system and methods facilitate proper scheduling of removal and replacement of ammonia canisters as well as provide real-time ammonia loads for canisters. These and other problems are addressed and resolved by the disclosed systems and method of the present application.

### SUMMARY

There is disclosed herein a system and method, each of which avoids the disadvantages of prior systems and methods while affording additional structural and operating advantages.

An ammonia delivery system generally comprising at least one canister containing a supply of a reductant, an exhaust gas after-treatment system having an injector fluidly coupled to the at least one canister, a controller for metering flow of reductant to the injector, and a status indicator electronically connected to the controller for indicating a fill-status of the at least one canister is disclosed.

In an embodiment of the disclosed system, the status indicator comprises an LED. In another embodiment, the status indicator comprises a series of LEDs. In another embodiment, the status indicator comprises an analog display. And, in still another embodiment, the status indicator comprises a digital display.

In various of the disclosed embodiments, the status indicator signals when the supply of ammonia reaches a predetermined level, such as empty or nearly-empty.

A method for delivering ammonia to a exhaust gas after-treatment system is also disclosed. Generally speaking, the method comprises the steps of heating a first supply of ammonia-containing storage material stored in a first canister to produce an ammonia gas, transporting the ammonia gas from the first canister to an ammonia injector coupled to an exhaust gas after-treatment system, metering the ammonia gas as it is transported to the ammonia injector, calculating a remaining supply of ammonia in the first canister, and indicating a status of the remaining supply of ammonia in the first canister.

As with the disclosed system, the step of indicating a status of the remaining supply in different embodiments of the method may include activating an LED, activating a series of LEDs, operating an analog or digital display, and operating another type of visual display.

In addition, a method for tracking ammonia level in an ammonia canister used for an exhaust gas after-treatment system is also disclosed. The method comprises the steps of attaching a memory storage device to an ammonia canister, determining the volume of ammonia in the canister, storing information relevant to the determined volume in the memory storage device, and periodically updating the information on the memory storage device.

In an embodiment of the tracking method, a further step of metering the use of the ammonia after the step of storing the information may be employed. The information may comprise a value corresponding to the amount of ammonia remaining in the canister or the amount used.

In an embodiment of the tracking method, the memory storage device comprises an RFID tag.

Finally, an ammonia canister status system is also disclosed. Generally speaking, the canister status system comprises a ammonia canister having stored therein a supply of an ammonia adsorbing/desorbing material, a memory storage device affixed to the canister, wherein the memory storage device contains information relevant to the volume of ammonia stored in the canister, a metering device for tracking the amount of ammonia delivered from the canister over a period of time, and an input device for periodically updating the memory storage device based on the amount of ammonia delivered from the canister as tracked by the metering device.

In embodiments of the canister status system, the memory storage device comprises an RFID tag, the input device comprises an RFID reader/writer electronically coupled to the metering device, and the metering device comprises an ammonia flow module.

### BRIEF DESCRIPTION OF THE DRAWINGS

FIG. 1 is a schematic overview of an ammonia storage and delivery system working in conjunction with a vehicle engine system, exhaust gas after-treatment system and the vehicle electronics;

FIG. 2 is a schematic illustrating an embodiment of the present on-board fill-status indicator system;

FIG. 3 is a schematic illustrating a partial cross-section of an ammonia canister and an embodiment of the present canister fill-status indicator system;

FIG. 4 illustrates a particular embodiment of the indicator system used in a three cartridge array;

FIG. 5 is a schematic illustrating an embodiment of a feed line coupler/canister connection status indicator;

FIG. 6 is a schematic illustrating an embodiment of a line-break detection and indicator system; and

FIGS. 7A-7D illustrate various embodiments of the placement of the line-break detection wire.

### DETAILED DESCRIPTION

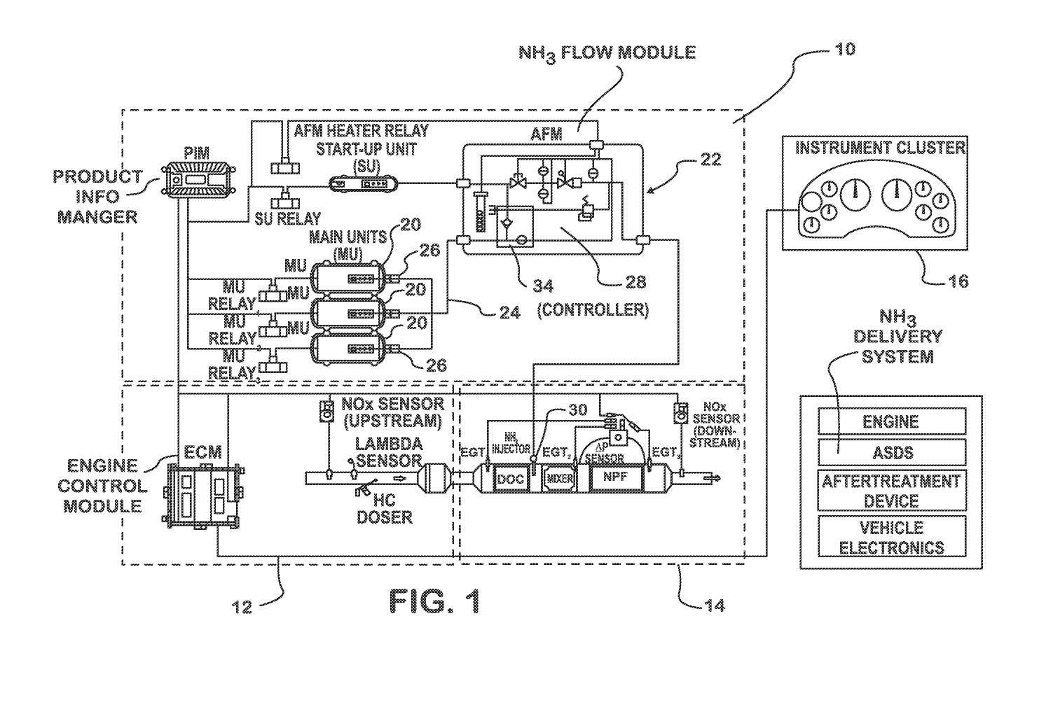

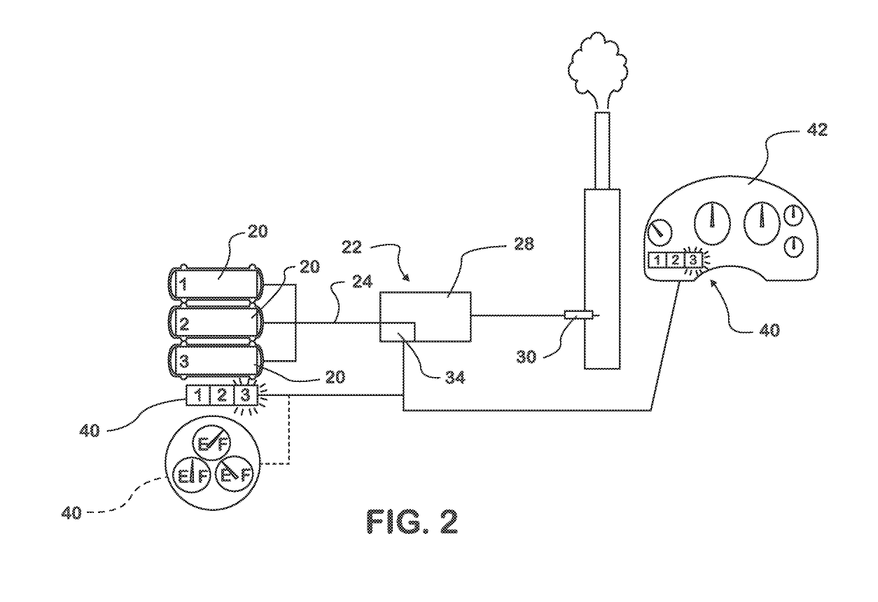

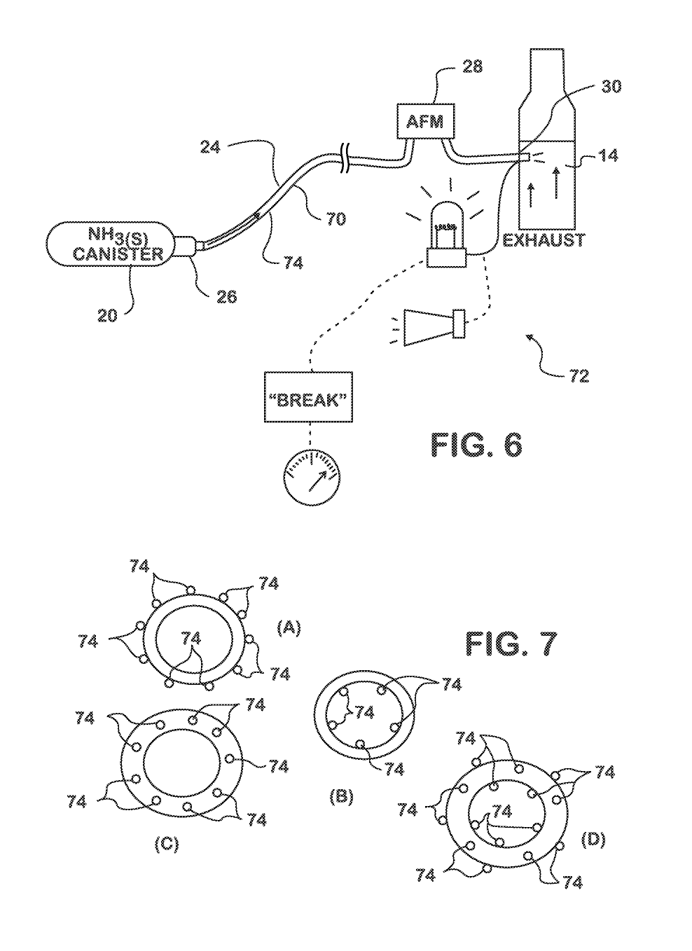

With reference to FIGS. 1-7, the embodiments of the system and methods are described to one of skill in the relevant art. Ammonia storage and dosing systems (ASDS), which are part of the exhaust gas NOₓ reduction (EGNR) system used in vehicles, may be comprised of several components, including a start-up canister, at least one main canister contained within a housing or storage compartment, wherein the canisters contain an ammonia adsorbing/desorbing material, an ammonia control module (AFM), a peripheral interface module (PIM), and possibly other components depending on vehicle specifications. Generally speaking, an ammonia delivery system, designated with the reference number 10 in the figures, typically works in conjunction with an internal combustion engine 12, an exhaust gas after-treatment system 14, and vehicle electronics 16.

In an embodiment of the ammonia delivery system 10, at least one canister 20 containing a supply of ammonia in an ammonia adsorbing/desorbing material is loaded into a carrier and secured in place. The canister 20 is connected to a metering system 22 via special tubing 24 and a special connector 26 to prevent leakage of the ammonia. In most systems, a plurality of canisters will be used to provide greater travel distance between recharging. However, the current system works sufficiently with a single canister for some applications and as desired or necessary. A heating jacket (not shown) is typically used around the canister to bring the ammonia adsorbing/desorbing material to a sublimation temperature.

Suitable ammonia adsorbing/desorbing material useful in the treatment of NOₓ in an exhaust stream includes metal-ammine salts, which offer a solid storage medium for ammonia, and represent a safe, practical and compact option for storage and transportation of ammonia. Ammonia may be released or desorbed from the metal ammine salt by heating the salt to temperatures in the range from 10° C. to the melting point to the metal ammine salt complex, for example, to a temperature from 30° to 700° C., and often to a temperature of from 100° to 500° C. It has been found that the ammine salt works well, having the general formula M(NH₃)ₙX_{z}, where M is one or more metal ions selected from the group consisting of Li, Mg, Ca, Sr, V, Cr, Mn, Fe, Co, Ni, Cu, and Zn, n is the coordination number in the range of from 2 to 12, and X is one or more anions, depending on the valence of M, selected from the group consisting of F, Cl, Br, I, SO₄, MoO₄, and PO₄. A saturated strontium chloride has been found to be ideal for the canister storage space. While embodiments using ammonia as the reductant are disclosed, the embodiments not limited to that reductant, and other reductants may be utilized instead of, or in addition to, ammonia for carrying out methods disclosed and claimed herein. Examples of such other, or additional reductants include, but are not limited to, urea, ammonium carbamate, and hydrogen.

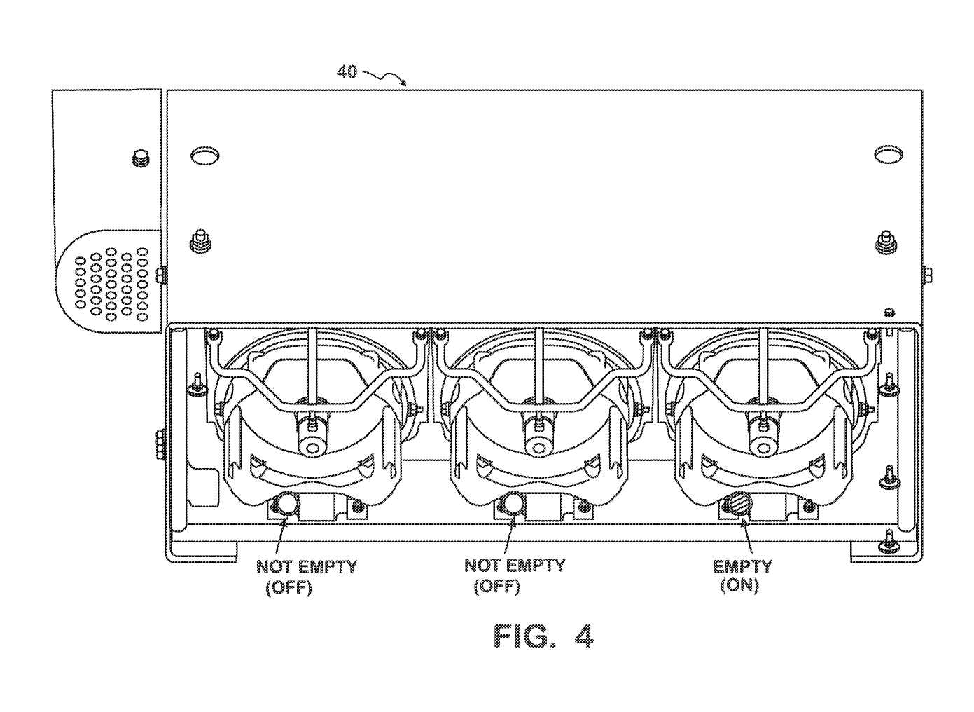

Once converted to a gas, the ammonia is metered at the ammonia flow module (AFM) 28 and is directed to an exhaust gas after-treatment system 14 having an ammonia injector 30, as shown in FIG. 1. The AFM 28 includes a controller 34 for metering flow of ammonia to an injector located within the after-treatment system 14. By “metering” it is meant that the controller 34 controls ammonia flow (rate and duration) and stores information about such details, possibly including for example: (1) the amount of ammonia required by the exhaust gas after-treatment system 14; (2) the amount of ammonia being delivered; (3) which of the multiple canisters provided ammonia; (4) the starting volume of deliverable ammonia in the canister; and (5) other such data which may be relevant to determining the amount of deliverable ammonia in each canister. The information may be monitored on a periodic or continuous basis. When the controller 34 determines that the amount of deliverable ammonia (i.e., approximately the amount of ammonia remaining in a particular canister) is below a predetermined level, a status indicator 40 electronically connected to the controller 34 is activated. The indicator 40 may be used to generally indicate a status of the canister 20, such as, for example, “Full” or “Empty” (see FIG. 4, for example) or it may be a type of analog or digital gauge used to indicate a specific amount of remaining deliverable ammonia.

In an embodiment for indicating a general threshold level of ammonia, the status indicator may be a single LED or other such simple visual indicator capable of signifying two separate conditions (e.g., LED “on”=empty and “off”=not empty). The predetermined threshold level may be “empty” or it may be, for example, when only 10% of deliverable ammonia remains in a canister. In a similar embodiment, the status indicator may include a series of LEDs (or other such visual indicators) to indicate ranges or a decreasing series of different threshold levels of deliverable ammonia remaining—e.g., one light=80%, two lights=50%, three lights=20%, etc. For more acute concerns, the status indicator may use an analog or digital display of remaining ammonia, much like a fuel gauge on a vehicle operates.

The visual indicator 40 may be mounted in proximity to the canister storage area to better advise those individuals charged with recharging and replacing empty canisters, and/or the indicator 40 may be mounted within the vehicle cab as part of the vehicle instrument cluster 42. When a first canister registers as “empty” or when it is removed from the canister mounting, the controller 34 automatically switches to a second supply of ammonia-containing material in a second canister.

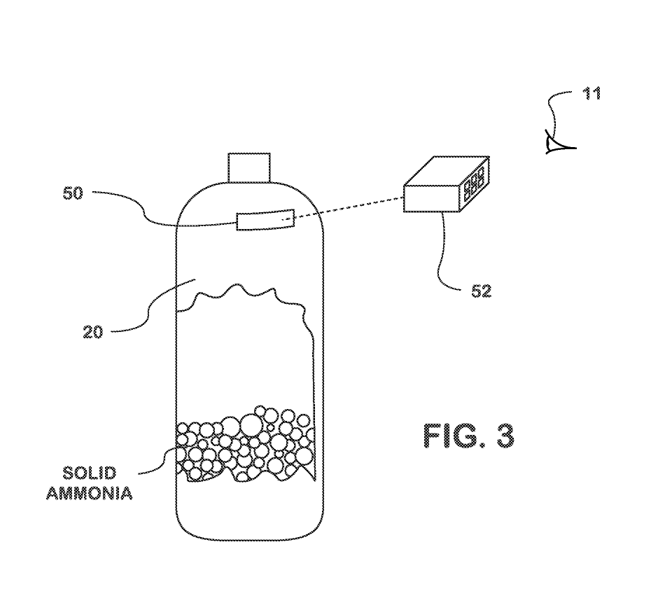

In another feature of an embodiment of the present system, a method for tracking the ammonia level in the ammonia canister 20 may be used on each canister, as illustrated in FIG. 3. That is, after a canister is removed from the vehicle's ammonia storage and delivery system, the remaining ammonia in the subject canister can be readily determined Generally speaking, the method comprises attaching a memory storage device to each ammonia canister, determining the volume of ammonia in the canister, storing information relevant to the determined volume in the memory storage device and periodically updating the information on the memory storage device as the ammonia is used.

As with the system 10 previously described, the method further comprises metering the use of the ammonia after the step of storing the information. The system controller 34 previously described is suitable for such metering and information storage. However, the controller 34 remains with the vehicle when the ammonia canisters are removed and, therefore, cannot suitably operate to make such information available for a removed canister. Instead, the memory storage device 50 affixed to the ammonia canister comprises an RFID tag 50 which can be read by a conventional RFID reader 52.

When a canister 20 is connected to the vehicle's ammonia storage and delivery system 10, an RFID reader/writer in the metering system 22 can frequently update the information stored on the RFID tag 50 as ammonia is depleted. As the controller 34 determines information about each coupled canister 20, the RFID reader/writer can easily write such information to the individual RFID tag 50 on each canister. Periodically or continuously updating the information merely comprises the steps of calculating the amount of ammonia remaining in the canister based on the flow rate and duration metered by the controller 34 and then storing a value relevant to the calculated amount on the memory storage device, i.e., the RFID tag 50.

In an embodiment of the canister ammonia volume tracking method, each ammonia canister 20 comprises a memory storage device (e.g., RFID tag) 50 affixed to the canister 20, wherein the memory storage device contains information relevant to the volume of ammonia stored in the canister at a given time. The vehicle components include a metering device for tracking the amount of ammonia delivered from the canister over a period of time, and an input device (e.g., RFID reader/writer) for periodically updating the memory storage device based on the amount of ammonia delivered from the canister 20 as tracked by the metering device 22.

Before the canister 20 is removed from the vehicle, the memory storage device 50 is updated with current ammonia load information. Then, a conventional handheld RFID reader 52 may be used at canister drop-off locations to determine the fill-status of each canister 20.

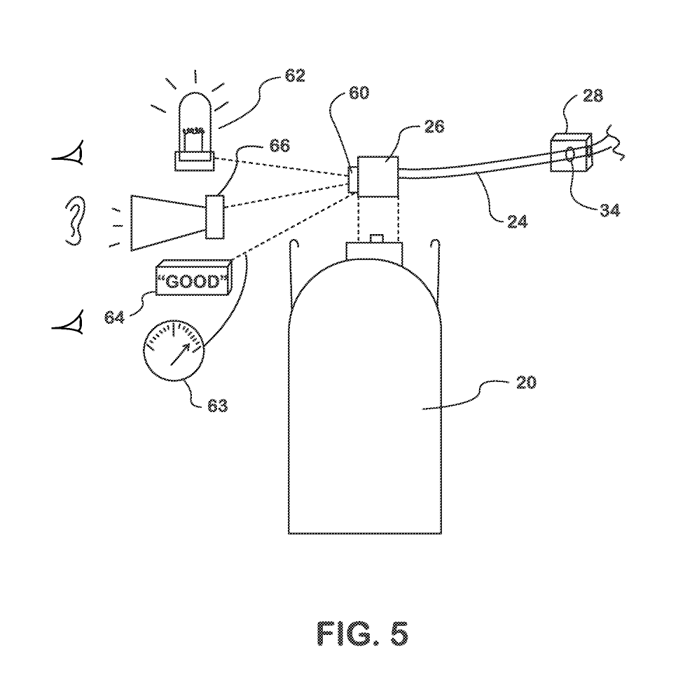

Referring to FIGS. 5-7, another aspect of the present system can be more readily understood. There are two additional points for potential ammonia leaks in the present system. The first is as a result of an improper coupling at any point in the ammonia flow, while the second is as a result of a break in the feed line.

As to leaks due to improper couplings, an embodiment of the system includes a positive connection indicator 60 which signals when a proper connection is achieved between the ammonia supply and the feed/delivery line 24. At least one canister 20 containing a supply of ammonia in “solid” form is connected, via a coupler 26 attached to an end of an ammonia delivery line 24, to an exhaust gas after-treatment system 14 having an ammonia injector 30. As previously described, an AFM 28 having a controller 34 is used for metering flow of the ammonia through the delivery line 24 to the injector 30. The connection status indicator 60 is used to provide a connection status of the coupler 26 to the canister 20 or a manifold (not shown) where multiple canisters are in use.

In an embodiment of the ammonia delivery system 10, the status indicator 60 may provide a visual signal 62, an audible signal 66, or both when a proper connection is made. A indicator is an LED or a series of LEDs. Alternatively, the visual signal 62 may be provided by an analog display/gauge 63 or a digital display 64. The audible signal 66 may be provided by an electronic annunciator using any variety or combination of sounds, including a click, beep, buzzer, etc. The status indicator 60 can be used to indicate either proper or improper connection or disconnection of the coupler 26 to the canister 20.

In use, the user is able to verify a proper connection between an ammonia canister 20 and a coupler attached to a feed line 24 for a delivery system 10. First, at least one ammonia canister 20 must be positioned for connection to a coupler 26 fixed to an ammonia feed line 24. Then, a mechanism such as the status indicator 60 must be set to activate upon a proper connection between the ammonia canister 20 and the coupler 26. When the user connects the coupler 26 to the ammonia canister 20, the user is able to determine whether the mechanism has been activated and, therefore, whether a proper connection has been made.

Where an activation of the status indicator 60 is not made—i.e., the connection is not proper—then the user may disconnect the coupler 26 from the ammonia canister 20 and then reconnect the coupler 26 to the ammonia canister 20. This disconnect/reconnect pattern can be followed until the user has determined that that the status indicator 60 has been activated.

The other potential for an ammonia gas leak is as a result of a break or disconnection of some kind in the ammonia delivery line 24. Accordingly, a feature of another embodiment of the ammonia delivery system 10 is the use of a line-break detector 70 and indicator 72. The line-break indicator 72 is connected and responsive to the detector 70 and is useful for visually and/or audibly indicating a disconnection or break at any point in the ammonia delivery line 24.

As with the connection indicator 60 described above, a mechanism for use with the line-break indicator 72 is an electronic annunciator connected to the line break detector 70. The annunciator may be a LED, a series of LEDs, or some other electronic visual signal, such as a analog or digital gauge. The annunciator may also emit an audible signal such as a beep, buzz, click, chime or the like.

The line-break detector 70 for the ammonia delivery system 10 comprises at least one wire 74 extending a length of the feed line 24, from the coupler 26 to the flow controller 28. The wire(s) 74 would have an electric signal constantly running there through such that a break in any part of the wire 74 would prevent transmission of the signal. A break in the wire(s) 74 would coincide with a break in the physical ammonia feed line 24. The termination of the electric signal would trigger the activation of the line-break indicator 72.

The positioning of the line-break detector 70 is variable. As illustrated in FIGS. 7A-7D, the wire(s) 74 may be positioned on an external surface of the feed line 24 (7A), integrated into a sidewall of the feed line 24 (7B), located within an interior of the feed line 24 (7C), or a combination of these locations (7D).

As still a further safety feature of the present ammonia delivery system 10, the ammonia flow controller 28 may be signaled to automatically stop the ammonia flow from the canister 20 through the feed line 24 upon an event related to a line break, such as termination of the electric signal or activation of the line-break indicator 72.

What is claimed is:

1. A reductant delivery system comprising:
at least one canister containing a supply of a reductant material;
an exhaust gas after-treatment system having an injector fluidly coupled to the at least one canister;
a controller for metering flow of reductant to the injector;
a status indicator electronically connected to the controller for indicating a status of the at least one canister.

2. The reductant delivery system of claim 1, wherein the status indicator comprises an LED.

3. The reductant delivery system of claim 1, wherein the status indicator comprises a series of LEDs.

4. The reductant delivery system of claim 1, wherein the status indicator comprises an analog display.

5. The reductant delivery system of claim 1, wherein the status indicator comprises a digital display.

6. The reductant delivery system of claim 1, wherein the status indicator signals when the supply of reductant reaches a predetermined level.

7. The reductant delivery system of claim 2, wherein the LED lights when the supply of reductant reaches a predetermined level.

8. The reductant delivery system of claim 3, wherein the series of LEDs light when the supply of reductant reaches each of a plurality of predetermined levels.

9. The reductant delivery system of claim 1, wherein the controller calculates a status of the supply of reductant based on an initial volume, a controlled flow rate and a measured time of flow.

10. The reductant delivery system of claim 1, wherein the reductant is ammonia.

11. A method for delivering ammonia to an exhaust gas after-treatment system, the method comprising the steps of:
heating a first supply of ammonia adsorbing/desorbing material stored in a first canister to produce an ammonia fluid;
transporting the ammonia fluid from the first canister to an ammonia injector coupled to an exhaust gas after-treatment system;
metering the ammonia fluid as it is transported to the ammonia injector;
calculating a remaining supply of ammonia in the first canister; and
indicating a status of the remaining supply of ammonia in the first canister.

12. The method of claim 11, wherein the step of metering the ammonia fluid comprises the steps of controlling a flow rate of the fluid ammonia and tracking the flow time of the fluid ammonia.

13. The method of claim 11, wherein the step of indicating a status of the remaining supply comprises the step of activating an LED.

14. The method of claim 11, wherein the step of indicating a status of the remaining supply comprises the step of activating a series of LEDs.

15. The method of claim 11, wherein the step of indicating a status of the remaining supply comprises the step of operating an analog display.

16. The method of claim 11, wherein the step of indicating a status of the remaining supply comprises the step of operating a visual display.

17. The method of claim 16, wherein the visual display is an LED.

18. The method of claim 16, wherein the visual display is a series of LEDs.

19. The method of claim 16, wherein the visual display is analog.

20. The method of claim 16, wherein the visual display is digital.

21. The method of claim 11, further comprising the step of switching to a second supply of ammonia in a second canister when the indicated status of the remaining supply of ammonia in the first canister reaches a predetermined level.

22. A method for delivering ammonia to a exhaust gas after-treatment system, the method comprising the steps of:
heating a supply of ammonia adsorbing/desorbing material to produce an ammonia fluid;
transporting the ammonia fluid to an ammonia injector coupled to the exhaust gas after-treatment system;
continuously metering the ammonia fluid as it is transported to the ammonia injector;
periodically calculating a remaining supply of ammonia;
continuously indicating a status of the remaining supply of ammonia.

22. A method for tracking an ammonia level in an ammonia canister used for an exhaust gas after-treatment system, the method comprising the steps of:
attaching a memory storage device to an ammonia canister;
determining the volume of ammonia in the canister;
storing information relevant to the determined volume in the memory storage device;
periodically updating the information on the memory storage device.

23. The method of claim 22, further comprising the step of metering the use of the ammonia after the step of storing the information.

24. The method of claim 22, wherein the information comprises a value corresponding to the amount of ammonia remaining in the canister.

25. The method of claim 22, wherein the memory storage device comprises an RFID tag.

26. The method of claim 23, wherein the step of periodically updating the information comprises the steps of calculating the amount of ammonia remaining in the canister and storing a value relevant to the calculated amount on the memory storage device.

27. The method of claim 26, wherein the memory storage device comprises an RFID tag.

28. An ammonia-storage canister status system comprising:
an ammonia canister having stored therein a supply of ammonia adsorbing/desorbing material;
a memory storage device affixed to the canister, wherein the memory storage device contains information relevant to the volume of ammonia stored in the canister;
a metering device for tracking the amount of ammonia delivered from the canister over a period of time; and
an input device for periodically updating the memory storage device based on the amount of ammonia delivered from the canister as tracked by the metering device.

29. The ammonia canister status system of claim 28, wherein the memory storage device comprises an RFID tag.

30. The ammonia canister status system of claim 29, wherein the input device comprises an RFID reader/writer electronically coupled to the metering device.

31. The ammonia canister status system of claim 28, wherein the metering device comprises an ammonia flow module.

32. The ammonia canister status system of claim 31, wherein the ammonia flow module controls flow of fluid ammonia from the canister.

33. The ammonia canister status system of claim 31, wherein the memory storage device comprises an RFID tag.

34. The ammonia canister status system of claim 33, wherein the input device comprises an RFID reader/writer electronically coupled to the metering device.
